(19) United States
(12) Patent Application Publication
(10) Pub. No.: US 2018/0350359 A1
(43) Pub. Date: Dec. 6, 2018

(54) METHODS, SYSTEMS, AND MEDIA FOR CONTROLLING A MEDIA CONTENT PRESENTATION DEVICE IN RESPONSE TO A VOICE COMMAND

(71) Applicants: Majd Bakar, San Jose, CA (US); Jhilmil Jain, Sunnyvale, CA (US)

(72) Inventors: Majd Bakar, San Jose, CA (US); Jhilmil Jain, Sunnyvale, CA (US)

(21) Appl. No.: 13/826,104

(22) Filed: Mar. 14, 2013

(51) Int. Cl. G10L 15/22

(52) U.S. Cl. CPC G10L 15/22

(57) ABSTRACT

Systems, methods, and media for controlling a media content presentation device in response to a voice command are provided. The systems comprising: at least one hardware processor that identifies a set of signals or a set of operations, wherein the signals or the operations cause media content to be presented, and wherein the signals or the operations occur in response to multiple user actions on a user input device; receives an indication of at least one keyword to be associated with the signals or the operations; associates the indication of the at least one keyword with the signals or the operations; detects a speaking of the at least one keyword using voice recognition; generates a set of signals, or causes to be executed a set of operations, in response to detecting the speaking of the at least one keyword; and causes the media content to be presented.

### TECHNICAL FIELD

The disclosed subject matter relates to methods, systems, and media for controlling a media content presentation device in response to a voice command.

### BACKGROUND

Voice control applications are bee ting increasingly popular. For example, electronic devices, such as mobile phones, automobile navigation systems, etc., are increasingly controllable by voice. More particularly, for example, with such an electronic device, a user may speak a voice command (e.g., a word or phrase) into a microphone, and the electronic device may receive the voice command and perform a single operation in response to the voice command. However, conventional approaches do not provide the user with the ability to execute multiple operations in response to a voice command. For example, a user currently does not have the ability to execute a custom set and/or a custom series of operations in response to a voice command.

Accordingly, new mechanisms for controlling a media content presentation device in responses to a voice command are desirable.

### SUMMARY

Methods, systems, and media for controlling a media content presentation device in response to a voice command are provided. In some implementations, systems for controlling a media content presentation device in response to a voice command are provided, the systems comprising: at least one hardware processor that: identifies a set of signals or a set of operations, wherein the set of signals or the set of operations cause media content to be presented, and wherein the set of signals or the set of operations occur in response to multiple user actions on a user input device, receives an indication of at least one keyword to be associated with the set of signals or the set of operations; associates the indication of the at least one keyword with the set of signals or the set of operations; detects a speaking of the at least one keyword using voice recognition; generates a set of signals, or causes to be executed a set of operations, in response to detecting the speaking of the at least one keyword; and causes the media content to be presented.

In some implementations, methods for controlling a media content presentation device in response to a voice command are provided, the methods comprising: identifying, using at least one hardware processor, a set of signals or a set of operations, wherein the set of signals or the set of operations cause media content to be presented, and wherein the set of signals or the set of operations occur in response to multiple user actions on a user input device; receiving an indication of at least One keyword to be associated with the set of signals or the set of operations; associating the indication of the at least one keyword with the set of signals or the set of operations; detecting a speaking of the at least one keyword using voice recognition; generating a set of signals, or causing to be executed a set of operations, in response to detecting the speaking of the at least one keyword; and causing the media content to be presented.

In some implementations, non-transitory computer-readable media are provided containing computer-executable instructions that, when executed by a processor, cause the processor to perform a method for controlling a media content presentation device in response to a voice command, the method comprising: identifying a set of signals or a set of operations, wherein the set of signals or the set of operations cause media content to be presented, and wherein the set of signals or the set of operations occur in response to multiple user actions on a user input device; receiving an indication of at least one keyword to be associated with the set of signals or the set of operations; associating the indication of the at least one keyword with the set of signals or the set of operations; detecting a speaking of the at least one keyword using voice recognition; generating a set of signals, or causing to be executed a set of operations, in response to detecting the speaking of the at least one keyword; and causing the media content to be presented.

In some implementations, systems for controlling a media content presentation device in response to a voice command are provided, the systems comprising: means for identifying a set of signals or a set of operations, wherein the set of signals or the set of operations cause media content to be presented, and wherein the set of signals or the set of operations occur in response to multiple user actions on a user input device; means for receiving an indication of at least one keyword to be associated with the set of signals or the set of operations means for associating the indication of the at least one keyword with the set of signals or the set of operations; means for detecting a speaking of the at least one keyword using voice recognition; means for generating a set of signals, or causing to be executed a set of operations, in response to detecting the speaking of the at least one keyword; and means for causing the media content to be presented.

In some implementations of these systems, the at least one keyword is received using voice recognition.

In some implementations of these systems, the systems further comprises means for receiving the speaking of the at least one keyword

In some implementations of these systems, the means for receiving the speaking of the at least one keyword is integrated with the user input device.

In some implementations of these systems, the means for identifying the set of signals or the set of operations, the means for receiving the indication of the at least one keyword to be associated with the set of signals or the set of operations, the means for associating the indication of the at least one keyword with the set of signals or the set of operations, the means for detecting the speaking of the at least one keyword using voice recognition, the means for generating the set of gnats, or causing; to be executed the set of operations, in response to detecting the speaking of the at least one keyword, and the means for causing the media content to be presented are part of the media content presentation device.

In some implementations of these systems, the means for identifying the set of signals or the set of operations, the means for receiving the indication of the at least one keyword to be associated with the set of signals or the set of operations, the means for associating the indication of the at least one keyword with the set of signals or the set of operations, the means for detecting the speaking of the at least one keyword using voice recognition, the means for generating the set of signals, or causing to be executed the set of operations, in response to detecting the speaking of the at least one keyword, and the means for causing the media content to be presented are part of the user input device.

### BRIEF DESCRIPTION OF THE DRAWINGS

Various objects, features, and advantages of the disclosed subject matter cat lie more fully appreciated with reference to the following detailed description of the disclosed subject matter when considered in connection with the following drawings, in which like reference numerals identify like elements.

FIG. 1A is a flow chart of an example of a process fur setting up a voice command in accordance with some implementations of the disclosed subject matter.

FIG. 1B is a flow chart of an example of a process for executing multiple operations in response to a voice command in accordance with some implementations of the disclosed subject matter.

FIG. 2 is an example of a user interface for initiating setup of a voice command in accordance with some implementations of the disclosed subject matter.

FIG. 3 is an example of a user interface for prompting a user to perform a set of user actions corresponding to a voice command in accordance with some implementations of the disclosed subject matter.

FIG. 4 is an example of a user interface for specifying a keyword or phrase for a voice command in accordance with some implementations of the disclosed subject matter.

FIG. 5 is an example of a user interface for receiving a voice command in accordance with some implementations of the disclosed subject matter.

FIG. 6 is a block diagram of an example of a system for executing multiple operations in response to a voice command in accordance with some implementations of the disclosed subject matter.

### DETAILED DESCRIPTION

In accordance with various implementations, as described in more detail below, mechanisms, which can include methods, systems, computer readable media, etc., for controlling a media content presentation device in response to a voice command are provided. These mechanisms can be used to generate a set or a series to, signals to, or cause a set or a series of operations to be executed on, a media content presentation device (e.g., such as a television) in response to a voice command received from a user so that media content is presented in some implementations.

Any suitable media content can be presented in some implementations. For example, media content can include television programs, movies, cartoons, music sound effects, audio books, streaming live content, pay-per-view programs, on-demand programs (e.g., as provided in video-on-demand (VOD) systems), Internet content (e.g., streaming content, downloadable content, Webcasts, etc.), etc.

In accordance with some implementations, in order to associate a set or a series of operations with a voice command, a user can perform a set of actions using any suitable input device (e.g., such as a remote control). The mechanisms can identify a set of signals or a set of operations, each of which can correspond to an action performed by the user. In some implementations, the set of signals or the set of operations can cause media content to be presented on a media content presentation device (e.g., such as a television). The mechanisms can also receive a keyword or phrase from the user. For example, the user can input a keyword or phrase using any suitable input device (e.g., such as a remote control). As another example, the user can input a keyword or phrase using a suitable microphone. The keyword or phrase can then be associated with the set of signals or the set of operations. In some implementations, the mechanisms can store the keyword and the set of signals or the set of operations in a suitable storage device.

Subsequently, in accordance with some implementations, the mechanisms can receive a voice command containing the keyword or Phrase from a user. For example, a user can speak the voice command containing the keyword or phrase into a suitable microphone. The mechanisms can then identify the keyword or phrase in the voice command using a suitable voice recognition algorithm. The mechanisms can then generate the set of signals or execute the set of operations associated with the keyword or phrase.

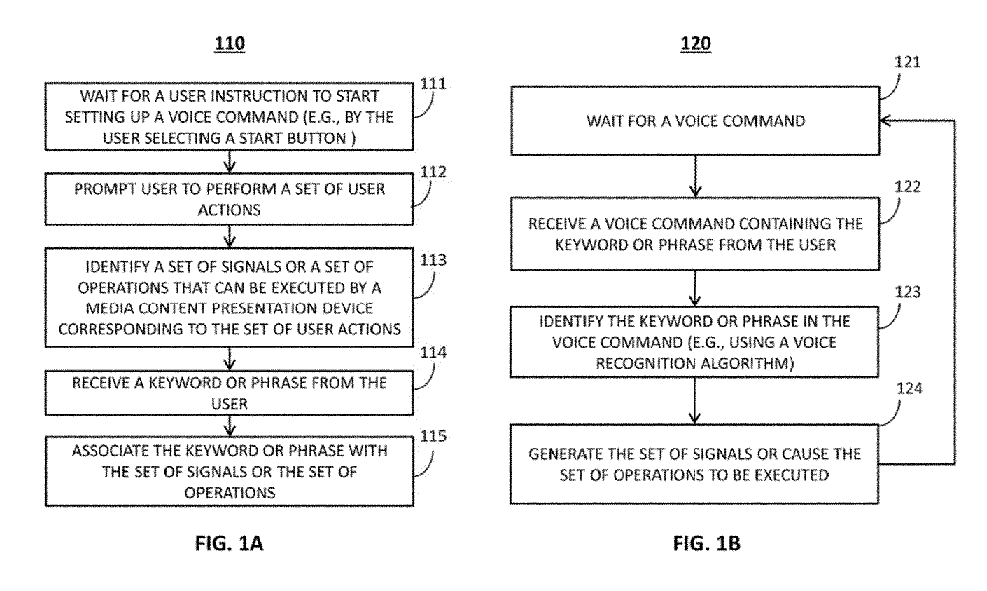

Turning to FIG. 1A, a flow chart of an example of a process 110 for setting up a voice command in accordance with some implementations of the disclosed subject matter is shown.

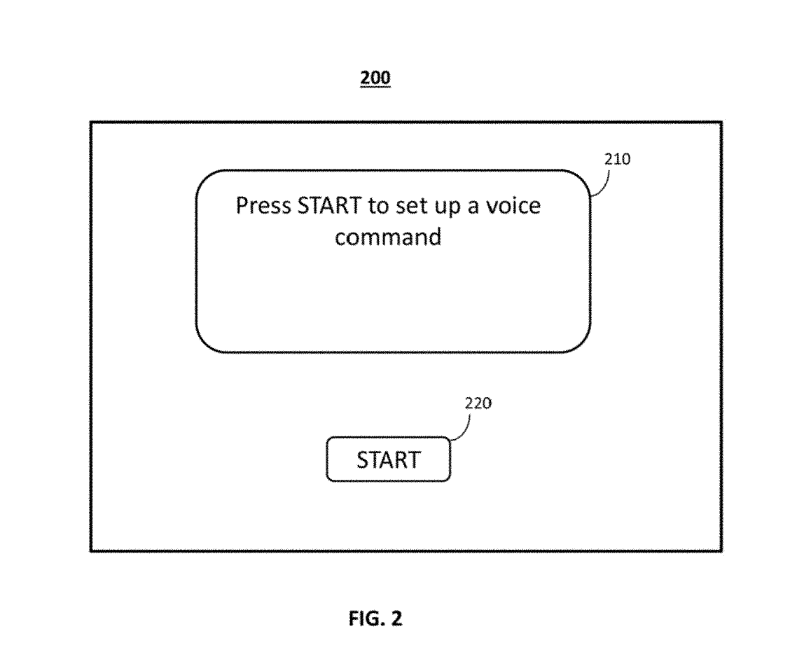

As illustrated, process 110 can start by waiting for a user instruction to start setting up a voice command at 111. Any suitable user interface can be presented to a user by process 110 at 111. For example, as illustrated in FIG. 2, user interface 200 can be presented to the user on a television at 111. As shown, user interface 200 can include a message window 210 and a start button 220. In message window 210, process 110 can present a message that can ask the user to start setting up a voice command. The user can start setting up a voice command by selecting start button 220.

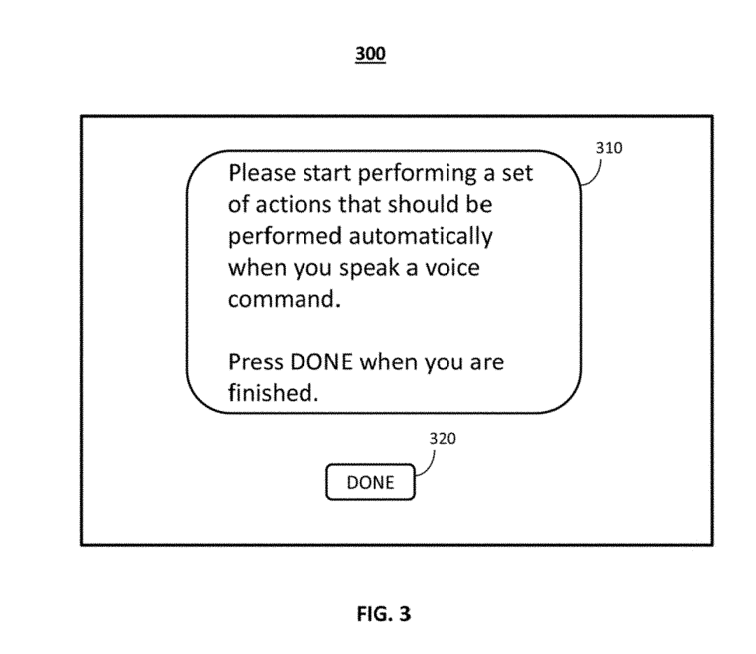

Turning back to FIG. 1A, next, at 112, process 110 can prompt the user to perform a set of user actions. The user can be prompted to perform the set of user actions in any suitable way. For example, a user interface 300, as illustrated in FIG. 3, can be presented to the user. As shown, user interface 300 can include a message window 310 and a button 320. In message window 310, process 110 can display a message that asks the user to perform a set of actions to be performed automatically when the user speaks a voice command.

Any suitable actions can be performed. For example, such actions can include file operations, menu operations, login operations, media content presentation operations, etc. More particularly, for example, the user can: open a preferred web browser; open a homepage of a website; sign in to the user's account using a remote control; and open a subscription page on the website.

After performing the set of actions, the user can select button 320 of user interface 300.

Referring back to FIG. 1A, at 113, process 110 can identify a set of signals or a set of operations that can be executed by a media content presentation device (e.g., such as a television) corresponding to the set of user actions. Any suitable set of signals or any suitable set of operations can be identified, and the set of signals and/or the set of operations can be identified in any suitable manner, in some implementations. For example, a set of signals, such as infra-red transmissions or radio frequency transmissions used to control the media content presentation device can be identified by detecting the signals as they are being transmitted from a user input device (e.g., such as a remote control) to the media content presentation device. As another example, a set of operations executed by the media content presentation device can identified by determining what functions are performed by the media content presentation device while the user is performing the set of user actions.

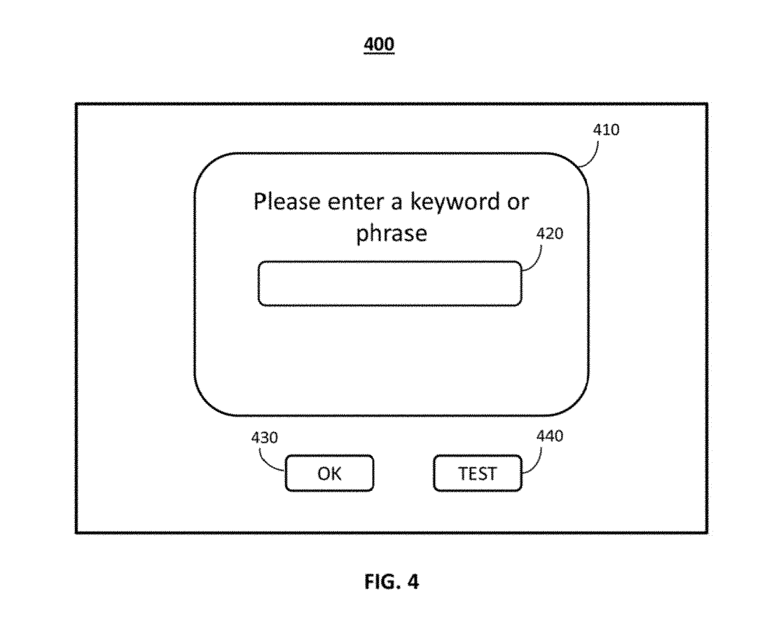

At 114, a keyword or phrase can be received from the user. The keyword or phrase can be received in an suitable manner. For example, the keyword or phrase can be received using a suitable graphical user interface. In a more particular example, as illustrated to FIG. 4, a user interface 400 can be presented to a user on a television. User interface 400 can include a message window 410, a text box 420, an OK button 430, and a test button 440. In message window 410, process 110 may ask the user to enter a keyword or phrase in text box 420, In some implementations, a user can enter the keyword or phrase using a remote control, in some implementations, a virtual keyboard can be displayed on user interface 400 to allow the user to enter a keyword or phrase. After entering the keyword or phrase, the user can accept the keyword or phrase by selecting button 430. Additionally or alternatively, the user can press test button 440 to test the voice command.

Turning back to FIG. 1A, at 115, process 110 can associate the set of signals or the set of operations identified at 113 with the keyword or phrase received at 114. The set of signals or the set of operations can be associated with the keyword or phrase in any suitable manner. For example, in some implementations, process 110 can store the keyword or phrase and the set of signals or the set of operations in association with the keyword or phrase in a suitable storage device.

Turning to FIG. 1B, a flow chart of an example of a process 120 for executing multiple operations m response to a voice command in accordance with some implementations of the disclosed subject matter is shown.

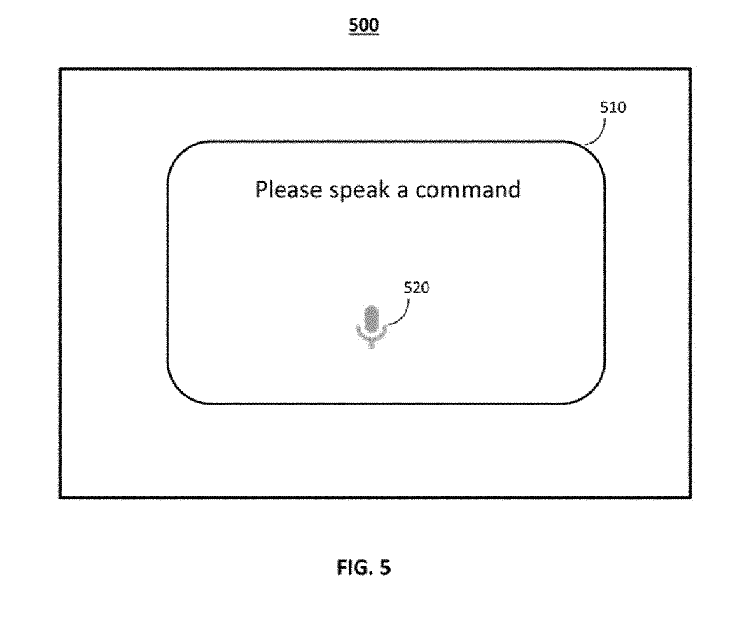

As illustrated, process 120 can start by waiting for a voice command at 121. While waiting, process 120 can present any suitable message to the user. For example, a user interface prompting the user to speak a command can be presented to the user at 121. In a more particular example, as illustrated in FIG. 5, a user interface 500 can be presented to the user. As illustrated, user interlace 500 can include a message window 510 and a microphone icon 520. In some implementations, the user can select microphone icon 520 to start inputting a voice command.

Turning back to FIG. 1B, at 122, a voice command containing the keyword or phrase can be received from the user. The voice command containing the keyword or phrase can be received in any suitable manner. For example, a voice command can be received from the user through a suitable microphone.

Next, at 123, process 120 can identify the keyword or phrase in the voice command. The keyword or phrase can be identified in the voice command in any suitable manner. For example, process 120 can analyze the voice command using any suitable speech recognition mechanism, such as a dynamic time warping based speech recognition model, a neural network-based speech recognition model, a hidden Markov model, etc., and then identify the keyword or phrase contained in the processed voice command.

Next at 124, process 120 can generate the set of signals associated with the keyword or phrase identified at 123, or cause the set of operations associated with the keyword or phrase identified at 123 to be executed. The set of signals can be generated or the set of operations can be caused to be executed, in any suitable manner. For example, process 120 can first retrieve from memory a set of signals or a set of operations corresponding to the keyword or phrase. Next, process 120 can generate the set of signals (e.g., as infrared or radio frequency transmissions) or cause the set of operations to be executed (e.g., by instructing a hardware processor to perform certain functions). As a more particular example, in response 10 identifying a keyword, process 120 can retrieve and generate signals to, or retrieve and cause to be executed operations to open the homepage of a video streaming website; sign in to a user's account and open the user's subscription page using a preferred web browser.

In some implementations, after performing step 124, process 120 can loop back to 121.

It should be understood that the above steps of the flow diagrams of FIGS. 1A and 1B can be executed or performed in any order or sequence not limited to the order and sequence shown and described in the figures. Also, some of the above steps of the flow diagrams of FIGS. 1A and 1B can be executed or performed substantially simultaneously where appropriate or in parallel to reduce latency and processing times. Furthermore, it should be noted that FIGS. 1-5 are provided as examples only. At least some of the steps shown in these figures may be performed in a different order than represented, performed concurrently, or altogether omitted.

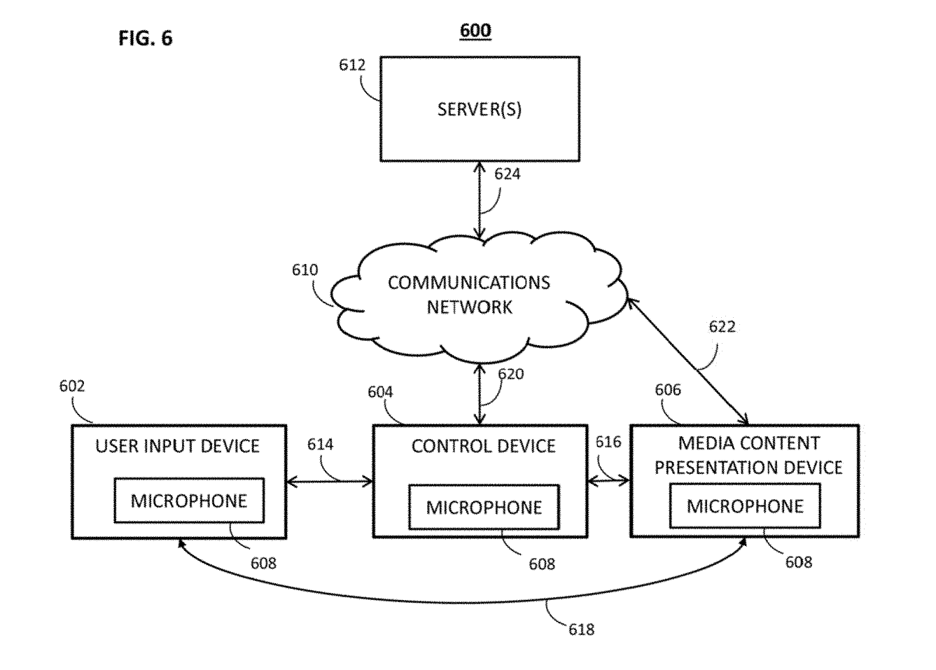

Turning to FIG. 6, a generalized block diagram of an example of a system 600 for executing multiple operations in response to a voice command in accordance with some implementations is shown. As illustrated, system 600 can include one or more user input devices 602, a control device 604, a media content presentation device 606, one or more microphones 608, a communications network 610, one or more servers 612, and communications links 614, 616, 618, 620, 622, and 624. In some implementations, one or more portions of or all of, processes 110 and/or 120 as illustrated in FIGS. 1A and 1B, and one or more of the interfaces illustrated in FIGS. 2-5, can be implemented by riser input device 602, control device 604, media content presentation device 606, and/or server(s) 612.

User input device 602 can be any suitable device that can receive user inputs. For example, user input device 602 can include a remote control, a mobile phone, a tablet computer, a laptop computer, a desktop computer, a personal data assistant (PDA), a portable email device, a game console, a voice recognition system, a gesture recognition system, a keyboard, a mouse, etc.

Media content presentation device 606 can be any device that can receive, convert, and/or present media content, such as a streaming media player, a media center computer, a CRT display, a LCD, a LED display, a plasma display, a touch screen display, a simulated touch screen, a television device, a tablet user device, a mobile phone, an audio amplifier and speakers, an audio book player, etc. In some implementations, media content presentation device 606 can be three-dimensional capable. Media content presentation device 606 can be provided as a stand-alone device or integrated with other elements of system 600.

Control device 604 can be any suitable device that can control a media content presentation device. For example, control device 604 can include a hardware processor, a communication interface, a transmitter (e.g., an infrared light transmitter, a radio frequency transmitter, etc.), a receiver (e.g., an infrared light receiver, a radio frequency receiver, etc.), and any suitable component. In some implementations, control device 604 can receive a voice command (e.g., using a suitable microphone), detect and identify a set of signals or a set of operations associated with the voice command (e g., using suitable receivers) while setting up the association (e.g., as described in process 110 of FIG. 1A), and generate a set of signals (e.g., using suitable transmitters) or control the media content presentation device to execute a set of operations by sending suitable instructions to the media content presentation device) while executing voice commands (e.g., as described in process 120 of FIG. 1B). In some implementations, control device 604 can be integrated with user input device 602 (e.g., as a remote control) and/or media content presentation device 606.

Microphone(s) 608 can be any suitable device that can receive acoustic input from a user. In some implementations, microphone(s) 608 can be integrated with user input device 602, control device 604, and/or media content presentation device 606. Alternatively, microphone 608 can be an external microphone (e.g., a microphone in an accessory such as a wired or wireless headset.)

Server(s) 612 can be any suitable server for providing media content, for performing one or more portions of processes 110 and/or 120 of FIG. 1 voice recognition and/or for perforating any other suitable function. Server(s) 612 can be implement using any suitable components. For example, each of the server(s) 612 can be implemented as a processor, a computer, a data processing device, a tablet computing device, a multimedia terminal, a mobile telephone, a gaming device, a set-top box, a television, etc., or a combination of such device.

In some implementations, each of user input device 602, control device 604, media content presentation device 606, and server(s) 612 can be any of a general purpose device such as a computer or a special purpose device such as a client, a server, etc. Any of these general or special purpose devices cart include any suitable components such as a hardware processor (which can be a microprocessor, digital signal processor, a controller, etc.), memory, communication interfaces, display controllers, input devices, a storage device (which can include a hard drive, a digital video recorder, a solid state storage device, a removable storage device, or any other suitable storage device), etc. In accordance with some implementations, each of user input device 602, control device 604, media content presentation device 606, and server(s) 612 can store in the storage device a keyword or phrase and a set of signals or a set of operations associated with the keyword.

Communications network 610 can be any suitable computer network including the Internet, an intranet, a wide-area network (“WAN”), a local-area network (“LAN”), wireless network, a digital subscriber line (“DSL”) network, a frame relay network, an asynchronous transfer mode (“ATM”) network, a virtual private network (“VPN”), a cable television network, a fiber optic network, a telephone network, a satellite network, or any combination of any of such networks.

User input device 602 and media content presentation device 606 can be connected to control device 604 by communications links 614 and 516, respectively. User input device 602 can be connected to media content presentation device 608 by communications link 618. Control device 604, media content presentation device 606, and server(s) 612 can be Connected to communications network 610 by communications links 620, 622, and 624, respectively.

Communication links 614, 616, 618, 620, 622, and 624 can be any suitable communication links, such as network links, dial-up links, wireless links, hard-wired links, any other suitable communication links, or a combination of such links.

Each of user input device 602, control device 604, media content presentation device 605, microphone 608, and server 612 can be implemented as a stand-alone device or integrated with other components of system 600.

In some implementations, any suitable computer readable media can be used storing instructions for performing the processes described herein. For example, in some implementations, computer readable media Can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission and/or any suitable intangible media.

In situations in which the systems discussed here collect personal information about users, or may make use of personal information, the users may be provided with an opportunity to control whether programs or features collect user information (e.g., information about a user's social network, social actions or activities, profession, a users preferences, or a user's current location), or to control whether and or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the User and used by a content server.

Accordingly, methods, systems, and media for executing multiple operations in response to a voice command are provided.

The provision of the examples described herein (as well as clauses phrased as “such as,” “e.g.,” “including,” and the like) should not be interpreted as limiting the claimed subject matter to the specific examples; rather, the examples are in ended to illustrate only some of many possible aspects.

Although the disclosed subject matter has been described and illustrated in the foregoing illustrative implementations, it is understood that the present disclosure has been made only by way of example, and that numerous changes in the details of implementation of the disclosed subject Matta can be made without departing from the spirit and scope of the disclosed subject matter, which is limited only by the claims that follow. Features of the disclosed implementations can be combined and rearranged in various ways.

1. A system for controlling a media content presentation device in response to a voice command, comprising:
a memory, and
at least one hardware processor that:
causes a message to be presented to a user that prompts the user to perform a plurality of user-selectable actions on a user input device that are to become collectively associated with the voice command, wherein each of the plurality of user-selectable actions can be performed individually;
after prompting the user to perform the plurality of user-selectable actions and before determining that the user has stopped performing the plurality of user-selectable actions on the user input device, detects an occurrence of a series of instructions or a series of operations that each correspond to one of the plurality of user-selectable actions, wherein the series of instructions or the series of operations cause media content to be presented, and wherein the series of instructions or the series of operations cause a user account associated with the user to be authenticated, and wherein the series of instructions or the series of operations occur in response to the plurality of user-selectable actions being performed on the user input device by the user;
after detecting the occurrence of the series of instructions or the series of operations, receives a user input indicating that the user has stopped performing the plurality of user-selectable actions;
receives, from the user, an indication of at least one keyword to become associated with the series of signals or the series of operations;
causes the indication of the at least one keyword to become associated with the series of instructions or the series of operations that each correspond to one of the plurality of user-selectable actions;
detects a speaking of the at least one keyword using voice recognition;
generates the series of signals, or causes to be executed the series of operations, in response to detecting the speaking of the at least one keyword; and
in response to generating the series of signals, or causing to be executed the series of operations that were generated or executed in response to detecting the speaking of the at least one keyword, causes the user account associated with the user to be authenticated and causes the media content to be presented.

2. The system of claim 1, wherein the hardware processor receives the indication of the at least one keyword using voice recognition.

3. The system of claim 1, further comprising a microphone that is configured to receive the speaking of the at least one keyword.

4. The system of claim 3, wherein the microphone is integrated with the user input device.

5. The system of claim 1, wherein the at least one hardware processor is part of the media content presentation device.

6. The system of claim 1, wherein the at least one hardware processor is part of the user input device.

7. A method for controlling a media content presentation device in response to a voice command, comprising:
causing a message to be presented to a user that prompts the user to perform a plurality of user-selectable actions on a user input device that are to become collectively associated with the voice command, wherein each of the plurality of user-selectable actions can be performed individually;
after prompting the user to perform the plurality of user-selectable actions on and before determining that the user has stopped performing a plurality of user-selectable actions, detecting, using at least one hardware processor, an occurrence of a series of instructions or a series of operations that each correspond to one of the plurality of user-selectable actions, wherein the series of instructions or the series of operations cause media content to be presented, and wherein the series of instructions or the series of operations cause a user account associated with the user to be authenticated, and wherein the series of instructions or the series of operations occur in response to the plurality of user-selectable actions being performed on the user input device by the user;
after detecting the occurrence of the series of instructions or the series of operations, receiving, using the at least one hardware processor, a user input indicating that the user has stopped performing the plurality of user-selectable actions;
receiving, from the user, an indication of at least one keyword to become associated with the series of signals or the series of operations;
causing the indication of the at least one keyword to become associated with the series of instructions or the series of operations that each correspond to one of the plurality of user-selectable actions;
detecting a speaking of the at least one keyword using voice recognition;
generating the series of signals, or causes to be executed the series of operations, in response to detecting the speaking of the at least one keyword; and
in response to generating the series of signals, or causing to be executed the series of operations that were generated or executed in response to detecting the speaking of the at least one keyword, causing the user account associated with the user to be authenticated and causing the media content to be presented.

8. The method of claim 7, wherein receiving the indication of the at least one keyword uses voice recognition.

9. The method of claim 8, wherein receiving the indication of the at least one keyword comprises receiving a speaking of the at least one keyword using a microphone.

10. The method of claim 9, wherein the microphone is integrated with the user input device.

11. The method of claim 7, wherein the at least one hardware processor is part of the media content presentation device.

12. The method of claim 7, wherein the at least one hardware processor is part of the user input device.

13. A non-transitory computer-readable medium containing computer-executable instructions that, when executed by a processor, cause the processor to perform a method for controlling a media content presentation device in response to a voice command, the method comprising:
causing a message to be presented to a user that prompts the user to perform a plurality of user-selectable actions on a user input device that are to become collectively associated with the voice command, wherein each of the plurality of user-selectable actions can be performed individually;
after prompting the user to perform the plurality of user-selectable actions on the user input device and before determining that the user has stopped performing a plurality of user-selectable actions on the user input device, detecting, using at least one hardware processor, an occurrence of a series of instructions or a series of operations that each correspond to one of the plurality of user-selectable actions, and wherein the series of instructions or the series of operations cause a user account associated with the user to be authenticated, wherein the series of instructions or the series of operations cause media content to be presented, and wherein the series of instructions or the series of operations occur in response to the plurality of user-selectable actions being performed on the user input device by the user;
after detecting the occurrence of the series of instructions or the series of operations, receiving, using the at least one hardware processor, a user input indicating that the user has stopped performing the plurality of user-selectable actions;
receiving, from the user, an indication of at least one keyword to be associated with the series of signals or the series of operations;
causes the indication of the at least one keyword to become associated with the series of instructions or the series of operations that each correspond to one of the plurality of user-selectable actions;
detecting a speaking of the at least one keyword using voice recognition;
generating the series of signals, or causes to be executed the series of operations, in response to detecting the speaking of the at least one keyword; and
in response to generating the series of signals, or causing to be executed the series of operations that were generated or executed in response to detecting the speaking of the at least one keyword, causing the user account associated with the user to be authenticated and causing the media content to be presented.

14. The method of claim 13, wherein receiving the indication of the at least one keyword uses voice recognition.

15. The method of claim 14, wherein receiving the indication of the at least one keyword comprises receiving a speaking of the at least one keyword using a microphone.

16. The method of claim 15, wherein the microphone is integrated with the user input device.

17. The system of claim 1, wherein the user input is received via a graphical user interface.

18. The computer-readable medium of claim 13, wherein the user input is received via a graphical user interface.

19. The method of claim 7, wherein the user input is received via a graphical user interface.
